(19) United States
(12) Patent Application Publication
(10) Pub. No.: US 2004/0018328 A1
(43) Pub. Date: Jan. 29, 2004

(54) Resinous tube and fuel system piping tube

(75) Inventors: Mitsuo Yamada, Kanagawa (JP); Hiroshi Kumagai, Kanagawa (JP); Katsumi Morohoshi, Kanagawa (JP); Yuichi Fujinuma, Kanagawa (JP)

Correspondence Address: FOLEY AND LARDNER, SUITE 500, 3000 K STREET NW, WASHINGTON, DC, 20007, US

(73) Assignee: NISSAN MOTOR CO., LTD.

(21) Appl. No.: 10/617,731

(22) Filed: Jul. 14, 2003

(30) Foreign Application Priority Data
Jul. 16, 2002 (JP) 2002-206720
May 21, 2003 (JP) 2003-143077

(51) Int. Cl. F16L 1/00

(52) U.S. Cl. 428/36.91; 138/137; 138/141

(57) ABSTRACT

A resinous tube for piping in a fuel system of an automotive vehicle. The resinous tube comprises at least one first cylindrical resin layer (A) including at least one resin selected from the group consisting of polybutylene terephthalate (PBT), polybutylene naphthalate (PBN), polyethylene terephthalate (PET) and polyethylene naphthalate (PEN). At least one second cylindrical resin layer (B) is formed generally coaxial with the at least one first cylindrical layer and includes at least one of polybutylene terephthalate (PBT) copolymer and polybutylene naphthalate (PBN) copolymer. In this tube, a cylindrical resin layer forming an innermost layer of the resinous tube is electrically conductive, fuel being in direct contact with an inner surface of the innermost layer.

### BACKGROUND OF THE INVENTION

This invention relates to improvements in a resinous tube which is preferably used for a tube for piping of a fuel system of an automotive vehicle, and more particularly to the resinous tube which includes therein an electrically conductive polyester resin and excellent in electrical conductivity, weight-lightness and rust-prevention and high in peel resistance between adjacent layers and fuel-barrier performance (fuel-permeation resistance) in a high temperature atmosphere and easily reusable.

Hitherto, a piping structure formed of metal, rubber, resin or a mixture of two or three kinds of these has been employed for an automotive vehicle fuel system piping such as a feed tube, a return tube, an evaporation hose, a filler hose and the like. Particularly recently, the piping formed of metal and having hitherto serving as the mainstream is being replaced with one formed of resin from the viewpoints of no rust being produced, weight-lightening being possible, and being advantageous in cost.

Additionally, static electricity is generated under friction when fuel flows. In order to remove this static electricity, a resinous tube provided with an electrical conductivity has been used. As a measure for providing an electrical conductivity to a resin, it is the most general to add a carbonaceous material such as carbon black to the resin, as disclosed in Japanese Patent Provisional Publication No. 7-286103 and Japanese Patent Publication No. 8-13902. It has been known that carbon black is mixed with a polyester resin to obtain an electrically conductive polyester resin.

### SUMMARY OF THE INVENTION

However, in general, the piping formed of resin has such a defect as to be inferior in fuel-permeation resistance as compared with one formed of metal. In order to meet a fuel evaporation regulation which is expected to become further strict in the future, it is strongly required to further suppress the fuel permeation.

A variety of developments for the purpose of improving the fuel-permeation resistance of the piping and the like formed of resins have been reported. However, no report has been found for a low cost resinous tube which is low in permeability of alcohol-contained fuel and practical in material and production.

In Japanese Patent Provisional Publication No. 5-164273, proposal is made for an arrangement in which a fluororesin (ethylene-tetrafluoroethylene copolymer) is used for an inner layer (barrier layer), an adhesive layer is provided for an intermediate layer, and polyamide 12 is used for an outer layer. However, in this case, there are problems in which the fluorine-based resin itself is high in cost, and additionally the adhesive layer for bonding the fluorine-based resin and polyamide 12 as the outer layer is high in cost. Against this, it has been considered to thin the layer containing the fluororesin in order to suppress a material cost. However, there is a limit to thin the layer containing the fluororesin maintaining a sufficient pressure resistance, so that it is impossible to achieve a sufficient thinning of the layer thereby making it impossible to attain a cost reduction.

Additionally, in order to obtain a further strong adhesive, there is a case in which fluororesin is extrusion-molded as an inner layer to which surface a chemical treatment liquid containing sodium-ammonia complex is applied thereby making a surface treatment for introducing active groups. However, this not only extremely complicates the production process but also further raises the cost.

In Japanese Patent Provisional Publication No. 11-156970 and Japanese Patent Provisional Publication No. 10-230556, an arrangement in which polyphenylene sulfide (PPS) is applied for a barrier layer. However, also in this case, there are problems in which it is necessary to form an adhesive layer, and the PPS layer and the adhesive layer are high in cost. Accordingly, this is difficult to become a combination which is realistic in cost level, similarly to the above-mentioned fluorine-based resin.

In all the cases, these problems result from the fact that the barrier layer and a protecting layer (the outer layer) are respectively formed of different materials. In other words, in case that the different materials are combined with each other, a strong adhesiveness cannot be obtained as it is, and therefore the adhesive layer is required, so that an at least-three layer structure including the adhesive layer is required. Additionally, there is a defect that the adhesive layer itself is high in cost so that the piping (laminated tube) becomes necessarily high in cost.

Additionally, in Japanese Patent Provisional Publication No. 10-30764 and Japanese Patent Provisional Publication No. 2000-55248, proposal has been made for a method in which a barrier layer (inner layer) and a protecting layer (outer layer) are bonded by a surface treatment such as that using plasma or the like without providing an adhesive layer. However, this complicates the production process and therefore is difficult to become a basic solution to the above problems. Additionally, with such a combination of the different materials, it is extremely difficult to reuse the marginal materials, which becomes a large problem.

It is an object of the present invention to provide an improved resinous tube which can effectively overcome a variety of drawbacks encountered in conventional resinous tubes.

Another object of the present invention is to provide a resinous tube which is provided with a good electrical conductivity for preventing its electrification, has a high permeation resistance not only to usual gasoline but also to alcohol-contained fuel, is sufficiently high in adhesiveness between a barrier layer (permeation-interrupting layer) and a supporting layer (layer for covering the permeation-interrupting layer), and is formed of a material which is easy in reuse of marginal materials and the like and low in cost.

An aspect of the present invention resides in a resinous tube comprising at least one first cylindrical resin layer (A) including at least one resin selected from the group consisting of polybutylene terephthalate (PBT), polybutylene naphthalate (PBN), polyethylene terephthalate (PET) and polyethylene naphthalate (PEN). At least one second cylindrical resin layer (B) is formed generally coaxial with the at least one first cylindrical layer and includes at least one of polybutylene terephthalate (PBT) copolymer and polybutylene naphthalate (PBN) copolymer. In this resinous tube, a cylindrical resin layer forming an innermost layer of the resinous tube is electrically conductive.

Another aspect of the present invention resides in a tube for piping in a fuel system of a vehicle. The tube comprises at least one first cylindrical resin layer (A) including at least one resin selected from the group consisting of polybutylene terephthalate (PBT), polybutylene naphthalate (PBN), polyethylene terephthalate (PET) and polyethylene naphthalate (PEN). At least one second cylindrical resin layer (B) is formed generally coaxial with the at least one first cylindrical layer and includes at least one of polybutylene terephthalate (PBT) copolymer and polybutylene naphthalate (PBN) copolymer. In this tube, a cylindrical resin layer forming an innermost layer of the resinous tube is electrically conductive, fuel being in direct contact with an inner surface of the innermost layer.

### BRIEF DESCRIPTION OF THE DRAWINGS

In the drawings, like reference numerals designate like elements and parts throughout all figures, in which:

FIG. 1A is a fragmentary perspective view of an embodiment of a resinous tube according to the present invention, in which an outer layer is partly cut out for the purpose of clearly showing the structure of the resinous tube;

FIG. 1B is a cross-sectional view of the resinous tube of FIG. 1A;

FIG. 2A is a fragmentary perspective view of another embodiment of the resinous tube according to the present invention, in which outer layers are partly cut out for the purpose of clearly showing the structure of the resinous tube;

FIG. 2B is a cross-sectional view of the resinous tube of FIG. 2A;

FIG. 3A is a fragmentary perspective view of a further embodiment of a resinous tube according to the present invention, in which outer layers are partly cut out for the purpose of clearly showing the structure of the resinous tube; and

FIG. 3B is a cross-sectional view of the resinous tube of FIG. 3A.

### DETAILED DESCRIPTION OF THE INVENTION

According to the present invention, a resinous tube has a multi-layer structure and comprises at least one cylindrical or tube-like resin (synthetic resin) layer A. Additionally, at least one cylindrical or tube-like resin (synthetic resin) layer B is formed generally coaxial with the at least one cylindrical resin layer A. The cylindrical resin layer A includes PBT (polybutylene terephthalate), PBN (polybutylene naphthalate), PET (polyethylene terephthalate) or PEN (polyethylene naphthalate), or a resin prepared in any combination of PBT, PBN, PET and PEN. The cylindrical resin layer B includes a resin formed of PBT copolymer or PBN copolymer, or a resin prepared in combination of PBT and PBN copolymers. Additionally, a cylindrical or tube-like resin (synthetic resin) layer forming the innermost layer of the plural layers constituting the resinous tube of the multi-layer structure is electrically conductive, so that the conductive cylindrical resin layer may form part of the at least one first cylindrical resin layer and the at least one second cylindrical resin layer, or may be independent from the at least one first cylindrical resin layer and the at least one second cylindrical resin layer.

The content of the above resins PBT, PBN, PET and/or PEN in the cylindrical resin layer A is preferably not less than 30% by weight, more preferably not less than 50% by weight in order to secure desired performances such as a fuel permeation resistance against alcohol-contained fuel. Similarly, the content of the above resins PBT copolymer and/or PBN copolymer in the cylindrical resin layer B is preferably not less than 30% by weight, more preferably not less than 50% by weight.

In the resinous tube of the present invention, a cylindrical or tube-like resin (synthetic resin) layer other than the cylindrical resin layers A, B may be added, for example, as the outermost layer or the intermediate layer which is relatively low in effect for fuel permeation resistance. Such a cylindrical resin layer preferably has a sufficient adhesiveness to the cylindrical resin layer A or the cylindrical resin layer B, and has a fuel permeation resistance equivalent to or higher than that of the cylindrical resin layer B.

The above-mentioned cylindrical resin layer A whose main component is low in permeability of fuel containing alcohol as compared with the above-mentioned cylindrical resin layer B and functions as a permeation-interrupting layer (this layer is referred hereinafter to as a “permeation-interrupting layer”). Additionally, the above-mentioned cylindrical resin layer B layer is relatively so soft as to ensure a flexibility of the whole resinous tube and functions to support the cylindrical resin layer A (this layer is referred hereinafter to as a “supporting layer”).

Hereinafter, embodiments of the resinous tube according to the present invention will be discussed.

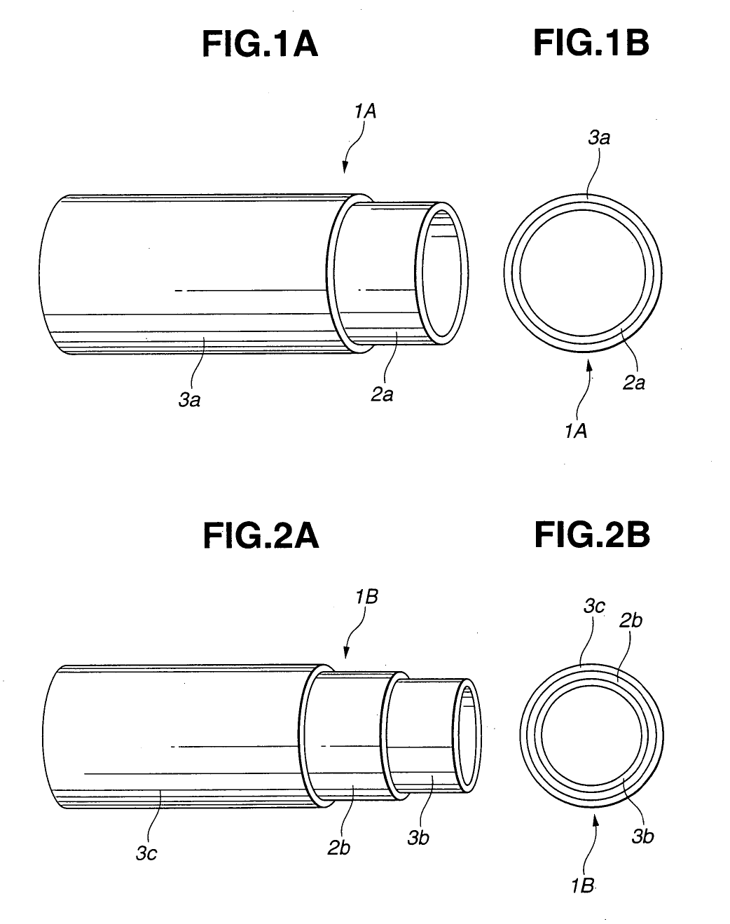

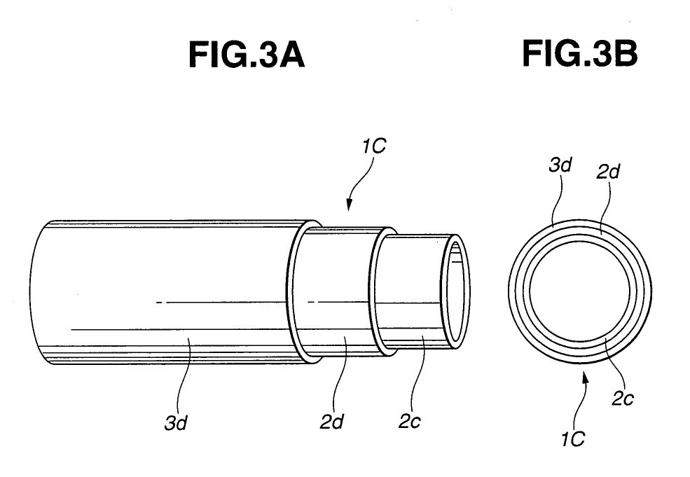

FIGS. 1A and 1B illustrate an embodiment in which the resinous tube 1A is formed by disposing supporting layer (cylindrical resin layer) 3a at the outer periphery of permeation-interrupting layer (cylindrical resin layer) 2a formed with an axial hollow through which fuel or the like is flowable. FIGS. 2A and 2B illustrate another embodiment in which the resinous tube 1B is formed by disposing supporting layer (cylindrical resin layer) 3b at the inner periphery of a tube having the same arrangement as that of the above-mentioned resinous tube 1A. In FIGS. 2A and 2B, the reference numeral 2b denotes the permeation-interrupting layer, and the reference numeral 3c denotes the supporting layer. FIGS. 3A and 3B illustrate a further embodiment in which the resinous tube 1C is formed by disposing permeation-interrupting layer (cylindrical resin layer) 2c different from permeation-interrupting layer (cylindrical resin layer) 2d at the inner periphery of a tube having the same arrangement as that of the above-mentioned resinous tube 1A. In FIGS. 3A and 3B, the reference numeral 3d denotes the supporting layer.

Here, permeation-interrupting layer 2a as the innermost layer in the resinous tube 1A is provided with an electrical conductivity and therefore electrically conductive. Similarly, supporting layer 3b as the innermost layer in the resinous tube 1B is provided with an electrical conductivity and therefore electrically conductive. Similarly, permeation-interrupting layer 2c as the innermost layer in the resinous tube 1C is provided with an electrical conductively and therefore electrically conductive.

Providing electrical conductivity to the innermost layer of the resinous tube of the multi-layer structure as discussed above can effectively remove static electricity generated under friction of liquid such as fuel to the inner wall of the resinous tube during flowing of the liquid through the inside of the resinous tube. Providing electrical conductivity to the innermost layer is accomplished by adding an electrically conductive additive or filler to the material or resin of the innermost layer. An example of the electrically conductive additive is a carbonaceous material in which carbon black is preferable. As the carbon black suitable for use in the resinous tube of the present invention, Ketjenblack (for example, “EC600JD” produced by Lion Corporation) is preferable because it has a highly developed structure, less impurity at its particle surface, and high in specific surface area. It will be understood that other carbonaceous materials than Ketjenblack may be used as the electrically conductive additive. The innermost layer of the resinous tube of the present invention preferably has a volume resistivity (serving as the standard of electrical conductivity) of not higher than 10⁶ Ω·cm in view of stability in resistance value on resin production lots and electrical conductivity of the resin upon being formed into the shape of a tube. It will be appreciated that the resinous tube is not limited to ones having two-layer or three-layer structures, and therefore may be ones which are formed by additionally laminating a plurality of permeation-interrupting layers and/or supporting layers.

Here, PBT, PBN, PET and/or PEN, or any combinations of these are contained as the main component of or form the above-mentioned permeation-interrupting layer (cylindrical resin layer A), by which the resinous tube can have an excellent permeation resistance in case that a mixture fuel containing alcohol such as ethanol or methanol or usual gasoline fuel flows through the inside of the pipe-shaped resinous tube. Additionally, in either one of a case that the permeation-interrupting layer is in contact with fuel and another case that the supporting layer is in contact with fuel, the layers are very low in deterioration with additives even if an amine-based detergent is added as the additives in fuel, because the basic skeleton of the layers is formed of polyester. Furthermore, the layers have a very excellent resistance to sour gasoline (deteriorated gasoline).

Further, both the above-mentioned permeation-interrupting layer and supporting layer are remarkably improved in sealing ability between them and metal, and therefore no slipping tends to occur when parts such as joints and metal fittings are inserted into the tube at the innermost layer, similarly to layers formed of fluorine-contained resin which has been conventionally used. PBN and PET are slightly higher in permeation resistance of fuel or the like in the above-mentioned four resins, and therefore it is more preferable to use PBN and/or PET in case that no cost problem occurs.

Furthermore, it may be made to mix or add, into the above-mentioned permeation-interrupting layer, homopolyester resin such as poly 1,4-cyclohexylene dimethylene terephthalate (PCT), homopolyester resin having cyclohexane and/or naphthalene ring such as liquid crystal polyester and/or the like, and/or copolymerized polyester having hexane ring such as copolymer of ethylene terephthalate (ET) and cyclohexylene dimethylene terephthalate (CT). In this case, permeation resistance can be further improved. Furthermore, it may be made to mix, into the above-mentioned permeation-interrupting layer, polyamide resins such as polyamide 6, polyamide 66 and the like, and/or polycarbonate resins such as bisphenol A polycarbonate and the like as far as the compatibility of them with the material of the above-mentioned permeation interrupting layer is not lost. In this case, a further low cost material arrangement can be obtained. Even polypropylene, polystyrene and the like which are incompatible with the material of the above-mentioned permeation-interrupting layer may be mixed into the permeation-interrupting layer similarly to the above-mentioned polyamide resins and the like, if treatment such as epoxy group introduction, maleic acid-modification or the like is applied to them. Also in this case, a further low cost material arrangement can be obtained.

The above-mentioned supporting layer (cylindrical resin layer B) contains as the main component or is formed of polybutylene terephthalate (PBT) copolymer and/or polybutylene naphthalate (PBN) copolymer, so that a high miscibility is exhibited at a laminated or contacting section between the supporting layer and the above-mentioned permeation-interrupting layer. Additionally, even only extrusion of both layers provides a sufficient adhesiveness so that an excellent delamination or peel resistance can be obtained in a high temperature atmosphere. Further, since no adhesive layer is required between the supporting layer and the permeation-interrupting layer, the resinous tube can be obtained at a very low cost. Furthermore, in the supporting layer, PBT and/or PBN may be mixed in addition to. PBT copolymer and/or PBN copolymer, which is effective for further improving the above-mentioned delamination.

Such PBT copolymer and PBN copolymer have an excellent flexibility and therefore effectively functions as the supporting layer for protecting the above-mentioned permeation-interrupting layer (such as, for protecting the layer from damaging). Further, since the PBT copolymer and the PBN copolymer have the flexibility, the resinous tube of the present invention can be readily disposed upon being bent, for example, when the resinous tube is installed as a fuel tube to a vehicle or the like. The above-mentioned PBT copolymer and PBN copolymer respectively have PBT and PBN in their basic skeleton and therefore have a flexibility required for the supporting layer and such a resistance against fuel. Since PBT and PBN have respectively low glass transition points (about 20° C. and 50° C.), it is easy that PBT and PBN obtain a low glass transition point and therefore can obtain an excellent flexibility at a low temperature of −40° C. required in the vehicle or the like. Additionally, it is preferable that the flexibility of the above-mentioned supporting layer is such that the flexural elastic modulus at ordinary temperature is not larger than 1.5 GPa. Particularly in case of the resinous tube having an outer diameter φ of 8 mm and a thickness of about 1 mm, it is desirable that the resinous tube is not larger than 1.0 GPa in flexural elastic modulus at ordinary temperature.

Additionally, the above-mentioned PBT copolymer and PBN copolymer may be constituted as either one of block-type (block PBT copolymer and PBN copolymer) and random type (random PBT copolymer and PBN copolymer). In case the above-mentioned PBT copolymer and PBN copolymer are of the block type, the hard segment is formed of PBT or PBN, and the soft segment is formed of polyether such as polytetramethylene glycol, polyhexamethylene glycol and the like, adipic acid ether such as ethylene adipate, butylene adipate and the like, polycaprolactone, polybalerolactone, and polyester such as aliphatic polycarbonate and the like, and the like, from the viewpoints of availability in the market and flexibility at low temperatures. Typically, it is preferable to use polyester-ether block copolymer elastomer in which PBT or PBN is used for the hard segment, and polyether is used for the soft segment, from the viewpoints of physical properties stability at low to high temperatures, workability and flexibility. Additionally, it is more preferable that the above-mentioned polyether is polytetramethylene glycol. Additionally, for the similar seasons, it is preferable to use polyester-ester copolymer elastomer in which PBT or PBN is for the hard segment, and polyester is for the soft segment. Additionally, it is more preferable that the above-mentioned polyester is polycaprolactone. In this case, a particularly excellent heat resistance can be obtained.

In case that the above-mentioned PBT copolymer and PBN copolymer are of the random type, one of polymerization processes is omitted thereby obtaining a lower cost material arrangement, as compared with a case of being of the block-type.

It is preferable from the viewpoint of obtaining a flexibility similar to that of the block type PBT and/or PBN, that the cylindrical resin layer B (supporting layer) includes or is formed of the PBT copolymer and/or PBN copolymer which is constituted of a copolymer polyester including an acid component and glycol component. The acid component includes at least one of terephthalic acid, ester-formable derivative of terephthalic acid, naphthalenedicarboxylic acid, ester-formable derivative of naphthalenedicarboxylic acid, and at least one of hydrogenated dimer acid and ester-formable derivative of hydrogenated dimer acid. The glycol component includes 1,4-butanediol. It is desirable that not less than 70 mole % of 1,4-butanediol is used from the viewpoint of raising a molecular weight.

Additionally, dimethyl terephthalate and the like are exemplified as the above-mentioned ester-formable derivative of terephthalic acid. Dimethyl naphthalate and the like are exemplified as the above-mentioned ester-formable derivative of naphthalenedicarboxylic acid. Further, the above-mentioned hydrogenated dimer acid is obtained by separating unsaturated fatty acid from low polymer by using a viscosity catalyst and being hydrogenated, and then by removing products such as trimer acid, monomer acid and the like. At this time, it is preferable that the purity of the hydrogenated dimer acid is not lower than 99%.

In concrete, PRIPOL 1008 (dimer acid having a carbon number of 36 and a ratio of aromatic type one/alicyclic type one/straight chain aliphatic type one=9/54/37 (mole %)) and PRIPOL 1009 (dimer acid having a carbon number of 36 and a ratio of aromatic type one/alicyclic type one/straight chain aliphatic type one=13/64/23 (mole %)) produced by Uniqema are exemplified as the suitable dimer acid. PRIPLAST 3008 (dimethyl ester of PRIPOL 1008) produced by Uniqema, and the like are exemplified as the ester-formable derivative of dimer acid. Additionally, EPOL 1010 produced by Cognis (Henkel) Japan Ltd. is also exemplified as a suitable example of the ester-formable derivative. These hydrogenated dimer acid and the ester-formable derivative of the hydrogenated dimer acid may be used singly or in combination.

A copolymer of or containing the above-mentioned hydrogenated dimer acid is preferably included in an amount of not less than 3 mole % in the above-mentioned acid (carboxylic acid) component from the viewpoint of flexibility at low temperatures and in an amount of not more than 30 mole % in the above-mentioned acid component from the viewpoint of workability. Outside this range, a sufficient flexibility cannot be obtained, and sufficient elasticity and stiffness cannot be obtained after fabrication of the tube. The copolymer composition of the above-mentioned dimer acid is contained more preferably in a rate ranging from 8 to 20 mole %, and more preferably in a rate ranging from 8 to 15 mole %.

It will be understood that polytetramethylene glycol (PTMG) may be further copolymerized with the copolymer containing the above-mentioned dimer acid thereby to form a copolymerized polyester excellent in flexibility in a low temperature range.

Furthermore, it is the most preferable that the innermost layer is formed of or includes the coplymer containing the above-mentioned dimer acid. This dimer acid copolymer is a copolymerized polyester having no ether group, different from a polyester-ether copolymer such as a copolymer containing PTMG, and therefore it is resistant against attack of peroxide radials contained in deteriorated gasoline. It is to be noted that the innermost layer of the resinous tube particularly tends to be subjected to such radial attack, and radical tends to be attracted to coupled electrons of carbon black as the electrically conductive filler. Thus, the innermost layer containing carbon black particularly tends to be subjected to attack from deteriorated gasoline. As a result, it is preferable that the innermost layer having an electrical conductivity is formed of a copolymerized polyester containing the dimer acid.

Further examples of the above-mentioned acid (dicarboxylic acid) are aromatic ones and aliphatic ones such as isophthalic acid, 2,6-naphthalene dicarboxylic acid, 4,4′-diphenyl dicarboxylic acid, 4,4′-diphenoxyethane dicarboxylic acid, sebacic acid, adipic acid and the like are exemplified. These may be used suitably in combination.

For the resinous tube of the present invention, as a modified example of the above case in which the innermost layer is formed of or includes the coplymer containing the above-mentioned dimer acid, the innermost layer is formed of or includes PBT in which ethylene-propylene rubber (EPR) particles are dispersed. The PBT in which EPR is dispersed is high in impact resistance in a low temperature range, particularly of not higher than −40° C., and highly durable to deteriorated gasoline because the resin has no ether group as discussed above. The above EPR particles have a particle size (diameter) of preferably not larger than 1 μm, more preferably not larger than 0.1 μm. It is preferable that the PBT contains 5 to 10% by weight of EPR, thereby providing a sufficient impact resistance.

As discussed above, in either case that the above-mentioned PBT copolymer and PBN copolymer are of the block type or the random type, it is easy to extrude the resinous tube by using the same cross head because the melting temperatures of the materials of the permeation-interrupting layer and the covering layer are close to each other. Additionally, since there is the miscibility between the permeation-interrupting layer and the supporting layer, a high adhesiveness is obtained between the layers.

The constituting materials of the above-mentioned permeation-interrupting layer and the supporting layer is not required to be particular ones, and therefore materials which are readily available in the market may be used for the constituting materials. Additionally, according to requirements, it may be suitably made to provide the constituting materials with heat resistance and hydrolysis resistance, and to provide the constituting materials with electrical conductivity by mixing filler and the like and to reinforce the constituting materials by mixing inorganic materials and the like.

Concerning thickness of each layer of the resinous tube, the electrically conductive resin layer forming the innermost layer preferably has a thickness within a range of 3 to 30%, more preferably within a range of from 5 to 30% of a total layer thickness (the whole thickness) of the resinous tube. A resin containing the electrically conductive filler such as Ketjenblack is insufficient in toughness particularly in a low temperature range, and therefore it is preferable to form the electrically conductive layer as thin as possible. However, taking account of the fact that the total layer thickness of a general tube is about 1 to 2 mm, it is very difficult to suppress a non-uniform layer thickness if the thickness of the innermost layer is less than 3% of the total layer thickness. Accordingly, the thickness of the innermost layer is preferably not less than 3%, more preferably not less than 5% of the total layer thickness of the resinous tube in view of obtaining stability in forming of the resinous tube. If the thickness of the innermost layer exceeds 30% of the total layer thickness of the resinous tube, it become difficult to secure the toughness as discussed above. Thus, the innermost layer having an electrical conductivity is preferably within the range of from 3 to 30% of the total layer thickness of the resinous tube.

Similarly, the resin (containing PBT, PBN, PET and/or PEN) constituting the permeation-interrupting layer (cylindrical resin layer A) is low in toughness as compared with the resin (containing PBT copolymer and/or PBN copolymer), and therefore it is degraded in flexibility at a low temperature range upon increasing the thickness of the permeation-interrupting layer. Accordingly, it is preferable that the thickness of the permeation-interrupting layer is not larger than 70% of the total layer thickness of the resinous tube in order to ensure sufficient impact resistance and flexibility at a low temperature range. Additionally, the permeation-interrupting layer has a thickness of preferably at least 3%, more preferably at least 5% of the total layer thickness of the resinous tube. For example, in case of a hollow tube (the resinous tube) having a thickness of 1 mm and having a three-layer arrangement as shown in FIGS. 2A and 2B, the hollow tube may take a layer arrangement having 0.1 mm of inner layer (3b), 0.3 mm of intermediate layer (2b) and 0.6 mm of outer layer (3c). The outer diameter of the resinous tube is different according to kinds of fluid flowing through the tube, in which the outer diameter is typically within a range of from about 5 to about 35 mm, and the thickness is typically about 1 mm to about 2 mm as discussed above.

Further, the resinous tube according to the present invention has a structure formed by laminating the permeation-interrupting layer and the supporting layer, and is arranged by combining the materials having the high miscibility. Therefore, not only adhesive is not required during fabrication of the tube but also the resinous tube can be very readily reused. For example, marginal materials produced during production process and disused fuel tubes can be pulverized and remolten so as to be reused as desired resinous parts.

Hereinafter, the present invention will be discussed in more detail with reference to Examples and Comparative Examples; however, the present invention is not limited to these Examples.

[Evaluation of Performance]

First, extrusion forming was conducted to form a laminated multi-layer (resinous) tube and a flat (resinous) plate for Examples 1 to 26 and Comparative Examples 1 and 2.

(A) Peel Test

A specimen having a width of 1 inch was taken from the formed tube and subjected to a 180° peel test according to JIS-K6256 to obtain a peel strength. Test result (evaluation of the peel strength) is shown in Table 2, in which “A”, “B”, “C” and “D” indicate relative evaluations to an evaluation (“C”) of Comparative Example 1. The evaluation “A” is better than the evaluation “B” which is better than the evaluation “C” which is equivalent to that of Comparative Example 1 and better than the evaluation “D”.

(B) Permeation Resistance Test

A specimen of the flat plate (formed under extrusion) was subjected to a permeation resistance test. The specimen was obtained by punching the extruded flat plate into the shape of a disc having a diameter (φ) of 70 mm. The specimen was put in the atmosphere of gasoline and alcohol-contained fuel at 60° C. for a certain time. Then,.an amount of permeation of the gasoline and the alcohol-contained fuel was measured. Results of this test are shown in Table 2. The gasoline used was regular gasoline which was available in the market and corresponded to No. 2 in JIS (Japanese Industrial Standard) K 2202. The alcohol-contained fuel used was a mixture of 90 parts by volume of the regular gasoline and 10 parts by volume of ethanol. Test results are shown in Table 2, in which “A”, “B”, “C” and “D” indicate relative evaluations to an evaluation (“C”) of Comparative Example 1. The evaluation “A” is better than the evaluation “B” which is better than the evaluation “C” which is equivalent to that of Comparative Example 1 and better than the evaluation “D”.

(C) Low Temperature Impact Test

The tube (formed under extrusion) was used as a specimen and subjected to a low temperature impact test according to JASO (Japanese Automotive Standard Organization) M 317 (item 8. 9) to obtain an impact resistance. In the impact test, an indenter having a weight of 0.45 kg and a rounded end (radius: 16 mm) was dropped onto the specimen from a position at a height of 305 mm in the atmosphere at −40° C. Test results are shown in Table 2, in which “A”, “B”, “C” and “D” indicate relative evaluations to an evaluation (“B”) of Comparative Example 1. The evaluation “A” is better than the evaluation “B” which is equivalent to that of Comparative Example 1 and better than the evaluation “C” which is better than the evaluation “D”.

### EXAMPLE 1

An inner layer (innermost layer) was formed of PBT copolymer having a volume resistivity value of 10⁶ Ω·cm (prepared by mixing 6 wt. % of Ketjenblack to “HYTREL 5577” (polyester-ether block copolymer elastomer) produced by Du Pont-Toray Co., Ltd.). An intermediate layer formed of PBT resin (“PBT 719” produced by Kanebo Gohsen Ltd.) was laminated outside or on the inner layer. The Ketjenblack was “EC600JD” produced by Lion Corporation. Then, an outer layer formed of PBT copolymer (“HYTREL 5577” (polyester-ether block copolymer elastomer) produced by Du Pont-Toray Co., Ltd.) was laminated outside or on the intermediate layer. The above lamination of the inner, intermediate and outer layers were made under extrusion thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm). The inner layer (supporting layer), the intermediate layer (permeation-interrupting layer) and the outer layer (supporting layer) respectively had layer thickness ratios (%) of 10, 30 and 60 relative to the total thickness (100%) of the above three layers of the resinous tube or the resinous flat sheet.

### EXAMPLE 2

A procedure of Example 1 was repeated with the exception that the inner layer, the intermediate layer and the outer layer respectively had layer thickness ratios (%) of 3, 30 and 67 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 3

A procedure of Example 1 was repeated with the exception that the inner layer, the intermediate layer and the outer layer respectively had layer thickness ratios (%) of 30, 30 and 40 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 4

A procedure of Example 1 was repeated with the exception that the inner layer, the intermediate layer and the outer layer respectively had layer thickness ratios (%) of 10, 3 and 87 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 5

A procedure of Example 1 was repeated with the exception that the inner layer, the intermediate layer and the outer layer respectively had layer thickness ratios (%) of 10, 70 and 20 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 6

A procedure of Example 1 was repeated with the exception that an inner layer (innermost layer) was formed of PBT copolymer having a volume resistivity value of 10⁴ Ω·cm (prepared by mixing 8 wt. % of Ketjenblack to “HYTREL 5577” (polyester-ether block copolymer elastomer) produced by Du Pont-Toray Co., Ltd.), thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 7

A procedure of Example 1 was repeated with the exception that an inner layer (innermost layer) was formed of PBT copolymer having a volume resistivity value of 10⁶ Ω·cm (prepared by mixing 6 wt. % of Ketjenblack to “PELPREN S-6001” (polyester-ester block copolymer elastomer) produced by Toyobo Co., Ltd.), thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 8

A procedure of Example 1 was repeated with the exception that an inner layer (innermost layer) was formed of random PBT copolymer having a volume resistivity value of 10⁶ Ω·cm, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

The above random PBT copolymer was prepared as follows:

A transesterification vessel was charged with dimethyl terephthalate, hydrogenated dimer acid (“PRIPLAS T3008” produced by Uniqema), 1,4-butanediol and tetra-n-butyltitanate as a transesterification and polymerization catalyst, and heated at 210° C. to accomplish reaction to form reaction product forming also methanol which was distilled out from this system, thereby accomplishing transesterification. After the distillation-out of methanol had been almost completed, the reaction product was transferred to a polymerization vessel in which a temperature was reached to 250° C. and a pressure was reached to 0.5 mmHg throughout the duration of 1 hour, followed by carrying out polycondensation for the reaction product, thereby obtaining the random PBT copolymer.

### EXAMPLE 9

A procedure of Example 1 was repeated with the exception that the inner layer was formed of a mixture of a polyester-ether block copolymer elastomer and the random PBT copolymer used in Example 8, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 10

A procedure of Example 1 was repeated with the exception that the inner layer was formed of a mixture of a polyester-ether block copolymer elastomer and the random PBT copolymer used in Example 8, and the intermediate layer is formed of PBN (“TQB-OT” produced by Teijin Chemicals Ltd.) in place of being formed of PBT, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 11

A procedure of Example 1 was repeated with the exception that the inner layer (innermost layer) was formed of random PBN copolymer having a volume resistivity value of 10⁶ Ω·cm (prepared by a method as recited below), the intermediate layer was formed of PBN (“TQB-OT” produced by Teijin Chemicals Ltd.), and the outer layer was formed of a mixture of polyester-ether block copolymer elastomer and the random PBT copolymer used in Example 8, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

The above random PBN copolymer was prepared by the following method:

A transesterification vessel was charged with naphthalate dicarboxylic acid, hydrogenated dimer acid (“PRIPLAS T3008” produced by Uniqema), 1,4-butanediol and tetra-n-butyltitanate as a transesterification and polymerization catalyst, and heated at 210° C. to accomplish reaction to form reaction product while forming also methanol which was distilled out from this reaction system, thereby accomplishing transesterification. After the distillation-out of methanol had been almost completed, the reaction product was transferred to a polymerization vessel in which a temperature was reached to 250° C. and a pressure was reached to 0.5 mmHg throughout the duration of 1 hour, followed by carrying out polycondensation for the reaction product, thereby obtaining the random PBN copolymer.

### EXAMPLE 12

An inner layer (innermost layer) was formed of PBT having a volume resistivity value of 10⁶ Ω·cm (prepared by mixing 6 wt. % of Ketjenblack to “PBT 719” produced by Kanebo Gohsen Ltd.). Then, an outer layer formed of PBT copolymer (“HYTREL 5577” (polyester-ether block copolymer elastomer) produced by Du Pont-Toray Co., Ltd.) was laminated outside or on the inner layer. The above lamination of the inner and outer layers was made under extrusion thereby forming a resinous tube of the three-layer structure as shown in FIGS. 1 and 2 (having an outer diameter of 8 mm and an inner diameter of 6 mm) and a resinous flat sheet of the three-layer structure (having a thickness of 1 mm). The inner layer (permeation-interrupting layer) and the outer layer (supporting layer) respectively had layer thickness ratios (%) of 30 and 70 relative to the total thickness (100%) of the above two layers of the resinous tube or the resinous flat sheet.

### EXAMPLE 13

A procedure of Example 12 was repeated with the exception that the inner layer was formed of PBN having a volume resistivity value of 10⁶ Ω·cm (prepared by mixing 6 wt. % of Ketjenblack to “TQB-OT” produced by Teijin Chemicals Ltd.), thereby forming a resinous tube of the three-layer structure as shown in FIGS. 1A and 1B (having an outer diameter of 8 mm and an inner diameter of 6 mm) and a resinous flat sheet of the three-layer structure (having a thickness of 1 mm) of this Example.

### EXAMPLE 14

An inner layer (innermost layer) was formed of PBT having a volume resistivity value of 10⁶ Ω·cm (prepared by mixing 6 wt. % of Ketjenblack to “PBT 719” produced by Kanebo Gohsen Ltd.). An intermediate layer formed of PBT resin (“PBT 719” produced by Kanebo Gohsen Ltd.) was laminated outside or on the inner layer. Then, an outer layer formed of PBT copolymer (“HYTREL 5577” (polyester-ether block copolymer elastomer) produced by Du Pont-Toray Co., Ltd.) was laminated outside or on the intermediate layer. The above lamination of the inner, intermediate and outer layers were made under extrusion thereby forming a resinous tube of the three-layer structure as shown in FIGS. 3A and 3B (having an outer diameter of 8 mm and an inner diameter of 6 mm) and a resinous flat sheet of the three-layer structure (having a thickness of 1 mm). The inner layer (permeation-interrupting layer), the intermediate layer (permeation-interrupting layer) and the outer layer (supporting layer) respectively had layer thickness ratios (%) of 10, 20 and 70 relative to the total thickness (100%) of the above three layers of the resinous tube or the resinous flat sheet.

### EXAMPLE 15

A procedure of Example 14 was repeated with the exception that the inner layer was formed of electrically conductive PBN having a volume resistivity value of 10⁶ Ω·cm (prepared by mixing 6 wt. % of Ketjenblack to “TQB-OT” produced by Teijin Chemicals Ltd.) in place of being formed of the electrically conductive PBT, and the intermediate layer was formed of PBN (“TQB-OT” produced by Teijin Chemicals Ltd.) in place of being formed of PBT, thereby forming a resinous tube of the three-layer structure as shown in FIGS. 3A and 3B (having an outer diameter of 8 mm and an inner diameter of 6 mm) and a resinous flat sheet of the three-layer structure (having a thickness of 1 mm) of this Example.

### EXAMPLE 16

An inner layer (innermost layer) was formed of the random PBT copolymer having a volume resistivity value of 10⁶ Ω·cm, used in Example 8. A first intermediate layer formed of a random PBT copolymer was laminated outside or on the inner layer. A second intermediate layer formed of PBN (“TQB-OT” produced by Teijin Chemicals Ltd.) was laminated outside or on the first intermediate layer. A third intermediate layer formed of PBT copolymer (“HYTREL 5577” (polyester-ether block copolymer elastomer) produced by Du Pont-Toray Co., Ltd.) was laminated outside or on the second intermediate layer. Additionally, an outer layer formed of PBT copolymer (“HYTREL 5577” (polyester-ether block copolymer elastomer) produced by Du Pont-Toray Co., Ltd.) was laminated outside or on the third intermediate layer. The above lamination of the inner, first intermediate, second intermediate, third intermediate and outer layers were made under extrusion thereby forming a resinous tube of the five-layer structure (having an outer diameter of 8 mm and an inner diameter of 6 mm) and a resinous flat sheet of the five-layer structure (having a thickness of 1 mm). The inner layer (supporting layer), the first intermediate layer (supporting layer), the second intermediate layer (permeation-interrupting layer), the third intermediate layer (supporting layer) and the outer layer (supporting layer) respectively had layer thickness ratios (%) of 10, 20, 30, 20, and 20 relative to the total thickness (100%) of the above three layers of the resinous tube or the resinous flat sheet.

### EXAMPLE 17

A procedure of Example 1 was repeated with the exception that the inner layer was formed of random PBT copolymer having a volume resistivity value of 10⁶ Ω·cm in place of being formed of the PBT copolymer, and the intermediate layer was formed of PEN produced by Teijin Chemicals Ltd. in place of being formed of PBT, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 18

A procedure of Example 1 was repeated with the exception that the inner layer was formed of random PBT copolymer having a volume resistivity value of 10⁶ Ω·cm in place of being formed of the PBT copolymer, and the intermediate layer was formed of PET produced by Takayasu Co., Ltd. and having an intrinsic viscosity of 0.7 in place of being formed of PBT, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 19

A procedure of Example 1 was repeated with the exception that the inner layer, the intermediate layer and the outer layer respectively had layer thickness ratios (%) of 2, 20 and 78 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 20

A procedure of Example 1 was repeated with the exception that the inner layer, the intermediate layer and the outer layer respectively had layer thickness ratios (%) of 40, 20 and 40 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 21

A procedure of Example 1 was repeated with the exception that the inner layer, the intermediate layer and the outer layer respectively had layer thickness ratios (%) of 10, 2 and 88 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 22

A procedure of Example 1 was repeated with the exception that the inner layer, the intermediate layer and the outer layer respectively had layer thickness ratios (%) of 10, 80 and 10 relative to the total thickness (100%) of the above three layers, thereby forming a resinous tube of the three-layer structure as shown in FIGS. 2A and 2B (having an outer diameter of 8 mm and an inner diameter of 6 mm) and a resinous flat sheet of the three-layer structure (having a thickness of 1 mm) of this Example.

### EXAMPLE 23

An inner layer (innermost layer) was formed of electrically conductive PBT (“B24ESD” produced by EMS-CHEMIE Showa Denko K.K.) which had a volume resistivity value of 10⁶ Ω·cm and contained maleic acid-modified EPR (ethylene propylene rubber) having a particle size of about 1 μm. A first intermediate layer formed of PBT resin (“PBT 719” produced by Kanebo Gohsen Ltd.) was laminated outside or on the inner layer. A second intermediate layer formed of a copolymer (“PBTSO1524” produced by Kanebo Gohsen Ltd.) including PBT, PTMG and dimer acid was laminated outside or on the first intermediate layer. Then, an outer layer formed of PBT copolymer (“HYTREL 5577” (polyester-ether block copolymer elastomer) produced by Du Pont-Toray Co., Ltd.) was laminated outside or on the second intermediate layer. The above lamination of the inner, first intermediate, second intermediate and outer layers were made under extrusion thereby forming a resinous tube of the four-layer structure as shown in FIGS. 2A and 2B (having an outer diameter of 8 mm and an inner diameter of 6 mm) and a resinous flat sheet of the four-layer structure (having a thickness of 1 mm). The inner layer (supporting layer), the first intermediate layer (permeation-interrupting layer), the second intermediate layer (supporting layer) and the outer layer (supporting layer) respectively had layer thickness ratios (%) of 5, 30, 35 and 30 relative to the total thickness (100%) of the above four layers of the resinous tube or the resinous flat sheet.

### EXAMPLE 24

A procedure of Example 23 was repeated with the exception that the inner layer (innermost layer) was formed of a resin which had been prepared by mixing 8 wt. % of Ketjenblack to PBT (“5201X11” produced by Toray Industries, Inc. and containing maleic acid-modified EPR having a particle size of about 0.1 μm) so as to have a volume resistivity value of 10⁶ Ω·cm, thereby forming a resinous tube of the four-layer structure (having an outer diameter of 8 mm and an inner diameter of 6 mm) and a resinous flat sheet of the four-layer structure (having a thickness of 1 mm) of this Example.

### EXAMPLE 25

An inner layer (innermost layer) was formed of a resin which had been prepared by mixing 8 wt. % of Ketjenblack to PBT (“5201X11” produced by Toray Industries, Inc. and containing maleic acid-modified EPR having a particle size of about 0.1 μm) so as to have a volume resistivity value of 10⁶ Ω·cm. An intermediate layer formed of PBN (“TQBX11” produced by Teijin Chemicals, Ltd.) was laminated outside or on the inner layer. Then, an outer layer formed of a copolymer (“L4310AN” produced by Teijin Chemicals, Ltd.) of PBN and PTMG was laminated outside or on the intermediate layer. The above lamination of the inner, intermediate and outer layers were made under extrusion thereby forming a resinous tube of the three-layer structure (having an outer diameter of 8 mm and an inner diameter of 6 mm) and a resinous flat sheet of the four-layer structure (having a thickness of 1 mm). The inner layer (supporting layer), the intermediate layer (permeation-interrupting layer), the outer layer (supporting layer) respectively had layer thickness ratios (%) of 5, 10 and 85 relative to the total thickness (100%) of the above three layers of the resinous tube or the resinous flat sheet.

### EXAMPLE 26

An inner layer (innermost layer) was formed of a resin which had been prepared by mixing 8 wt. % of Ketjenblack to PBT (“5201X11” produced by Toray Industries, Inc. and containing maleic acid-modified EPR having a particle size of about 0.1 μm) so as to have a volume resistivity value of 10⁶ Ω·cm. A first intermediate layer formed of a copolymer (“L4310AN” produced by Teijin Chemicals, Ltd.) of PBN and PTMG was laminated outside or on the inner layer. A second intermediate layer formed of PBN (“TQB-OT” produced by Teijin Chemicals, Ltd.) was laminated outside or on the first intermediate layer. A third intermediate layer formed of a copolymer (“L4310AN” produced by Teijin Chemicals, Ltd.) of PBN and PTMG was laminated outside or on the intermediate layer. An outer layer formed of a copolymer (“HYTREL 5577” (polyester-ether block copolymer elastomer) produced by Du Pont-Toray Co., Ltd.) of PBT and PTMG was laminated outside or on the third intermediate layer. The above lamination of the inner, first intermediate, second intermediate, third intermediate and outer layers was made under extrusion thereby forming a resinous tube of the five-layer structure (having an outer diameter of 8 mm and an inner diameter of 6 mm) and a resinous flat sheet of the five-layer structure (having a thickness of 1 mm). The inner most layer (supporting layer), the first intermediate layer (supporting layer), the second intermediate layer (permeation-interrupting layer), the third intermediate layer (supporting layer) and the outer layer (supporting layer) respectively had layer thickness ratios (%) of 5, 5, 10, 5 and 75 relative to the total thickness (100%) of the above five layers of the resinous tube or the resinous flat sheet.

### COMPARATIVE EXAMPLE 1

An inner layer was formed of ethylene tetrafluoroethylene copolymer (ETFE). An intermediate layer formed of a mixture of ETFE and polyamide 12 (PA12) was laminated outside or on the inner layer. Then, an outer layer formed of PA12 was laminated outside or on the intermediate layer. The above lamination of the inner, intermediate and outer layers were made under extrusion thereby forming a resinous tube of the three-layer structure (having an outer diameter of 8 mm and an inner diameter of 6 mm) and a resinous flat sheet of the three-layer structure (having a thickness of 1 mm). The inner layer, the intermediate layer and the outer layer respectively had layer thickness ratios (%) of 15, 15 and 70 relative to the total thickness (100%) of the above three layers of the resinous tube or the resinous flat sheet. The peal strength was a result measured at an interface between the inner layer and the intermediate layer.

### COMPARATIVE EXAMPLE 2

Only polyamide 11 (PA 11) was extruded to form a single-layer resinous tube (having an outer diameter of 8 mm and inner diameter of 6 mm in an extruded state) and a resinous flat sheet (having a thickness of 1 mm) of this Comparative Example.

The layer arrangements and layer materials of the resinous tubes produced according to Examples 1 to 26 and Comparative Examples 1 and 2 are summarized in and tabulated as Tables 1A and 1B. Additionally, the test results of the test, the permeation resistance test and the low temperature impact rest are shown in Table 2.

As apparent from the test results shown in Table 2, all the resinous tubes of Examples 1 to 26 exhibit peel strength and permeation resistance performance equivalent or higher than those of the resinous tubes of Comparative Examples 1 and 2. Concerning the peel strength, all the resinous tubes of Examples 1 to 26 exhibit higher values than those of the resinous tubes of Comparative Examples 1 and 2. This depicts that the resinous tubes of the present invention have excellent adhesiveness between layers without requiring no particular bonding process. Additionally, it is depicted that permeation resistance performance and low temperature impact resistance can be well balanced when the total thickness of the cylindrical resin layer A is 3 to 70% of the total thickness of all the layers of the resinous tube, upon comparison between the test results of Examples 21 and 22 and other Examples. It is further depicted that a sufficient low temperature impact resistance can be easily obtained when the thickness of the electrically conductive resin layer forming the innermost layer is 3 to 30% of the total thickness of all the layers of the resinous tube, upon comparison between the test results of Examples 19 and 20 and other Examples. It is further depicted that the resinous tubes can be improved in impact resistance at low temperatures by using the resin including PBT in which maleic acid-modified EPR is dispersed, as the material of the electrically conductive resin layer forming the innermost layer of the resinous tube, from the test results of Examples 23 to 26.

Although the present invention has been discussed in detail with reference to Examples, it will be understood that the present invention is not limited to those, and therefore a variety of variations may be made within the scope of the present invention. For example, to the material resins of the respective layers of the resinous tube of the present invention, oxidation inhibitor, thermal stabilizer (for example, hindered phenol, hydroquinone, thioether, and phosphites, or any mixtures of these or substitution products or the like of these), ultraviolet ray absorbent (for example, resorcinol, salicylate, benzotriazole, benzophenone and the like), lubricant or mould releasing agent (for example, silicone resin, montanic acids and salts of these, stearic acids and salts of these, stearyl alcohol, stearyl amide and the like), coloring agent including dye (for example, nitrocine and the like) or pigment (for example, cadmium sulfide, phthalocyanine and the like), additive-impregnated liquid (for example, silicone oil and the like), crystalline nucleus (for example, talc, kaolin and the like), and the like may added singly or in suitable combinations.

Additionally, although the cross-section of the resinous tube is typically of circular shape or elliptical shape, it may be of shapes other than these. Further, it is a matter of course that a permeation resistance can be obtained by using the laminate employing the materials of the respective layers in shapes other than the shape of the tube, for example, a shape like that (semicylindrical) of a rain gutter or a sheet-shape. Furthermore, the resinous tube can be easily produced by extrusion molding or blow molding, and is not limited in shape to a straight tube and therefore a corrugation-shape (like a bellows) may be applied to the resinous tube.

As appreciated from the above, according to the present invention, the resinous tube is formed into the multi-layer structure using certain polyesters as material resins, and therefore it has a high permeation resistance not only for usual gasoline but also for alcohol-contained fuel and sufficient high in adhesiveness between a barrier layer (permeation-interrupting layer) and a protective layer (supporting layer for covering the permeation-interrupting layer) while maintaining a good electrical conductivity for preventing its electrification. Additionally, waste pieces (marginal materials) and the like of the resinous tube can be accomplished easily and at low cost.

The entire contents of Japanese Patent Applications P2002-206720 (filed Jul. 16, 2002) and P2003-143077 (filed May 21, 2003) are incorporated herein by reference.

Although the invention has been described above by reference to certain embodiments and examples of the invention, the invention is not limited to the embodiments and examples described above. Modifications and variations of the embodiments and examples described above will occur to those skilled in the art, in light of the above teachings. The scope of the invention is defined with reference to the following claims.

TABLE 1A

| | | | | Intermediate layer | | | | | | | |
|---|---|---|---|---|---|---|---|---|---|---|---|
| | Inner layer (innermost layer) | | | 1 | | 2 | | 3 | | Outer layer | |
| | | Volume | Layer | | Layer | | Layer | | Layer | | Layer |
| | | resistivity | thickness | | thickness | | thickness | | thickness | | thickness |
| | Material | value | ratio | Material | ratio | Material | ratio | Material | ratio | Material | ratio |
| Item | resin | (Ω · cm) | (%) | resin | (%) | resin | (%) | resin | (%) | resin | (%) |
| Comp. | ETFE | — | 15 | PA12 + | 15 | — | — | — | — | PA12 | 70 |
| Example 1 | | | | ETFE | | | | | | | |
| Comp. | PA11 | — | 100 | — | — | — | — | — | — | — | — |
| Example 2 | | | | | | | | | | | |
| Example 1 | Conductive | 10⁶ | 10 | PBT | 30 | — | — | — | — | Polyester-ether | 60 |
| Example 2 | polyester-ether | | 3 | | 30 | — | — | — | — | block | 67 |
| Example 3 | block | | 30 | | 30 | — | — | — | — | copolymer | 40 |
| Example 4 | copolymer | | 10 | | 3 | — | — | — | — | (PBT/PTMG | 87 |
| Example 5 | (PBT/PTMG) | | 10 | | 70 | — | — | — | — | | 20 |
| Example 6 | | 10⁴ | 10 | | 30 | — | — | — | — | | 60 |
| Example 7 | PBT/PCL | 10⁶ | 10 | | 30 | — | — | — | — | | 60 |
| | (poly- | | | | | | | | | | |
| | caprolacolone | | | | | | | | | | |
| Example 8 | PBT/dimer acid | 10⁶ | 10 | | 30 | — | — | — | — | | 60 |
| Example 9 | PBT/dimer | 10⁶ | 10 | | 30 | — | — | — | — | | 60 |
| | acid/PTMG | | | | | | | | | | |
| Example 10 | PBT/dimer acid | 10⁶ | 10 | PBN | 30 | — | — | — | — | | 60 |
| Example 11 | PBN/dimer | 10⁶ | 10 | | 30 | — | — | — | — | PBT/dimer | 60 |
| | acid | | | | | | | | | acid/PTMG | |
| Example 12 | Conductive | 10⁶ | 30 | — | — | — | — | — | — | Polyester-ether | 70 |
| | PBT | | | | | | | | | block | |
| Example 13 | Conductive | 10⁶ | 30 | — | — | — | — | — | — | copolymer | 70 |
| | PBN | | | | | | | | | (PBT/PTMG) | |
| Example 14 | Conductive | 10⁶ | 10 | PBT | 20 | — | — | — | — | | 70 |
| | PBT | | | | | | | | | | |
| Example 15 | Conductive | 10⁶ | 10 | PBN | 20 | — | — | — | — | | 70 |
| | PBN | | | | | | | | | | |

TABLE 1B

| | | | | Intermediate layer | | | | | | | |
|---|---|---|---|---|---|---|---|---|---|---|---|
| | Inner layer (innermost layer) | | | 1 | | 2 | | 3 | | Outer layer | |
| | | | Layer | | Layer | | Layer | | Layer | | Layer |
| | | Volume | thick- | | thick- | | thick- | | thick- | | thick- |
| | | resistivity | ness | | ness | | ness | | ness | | ness |
| | Material | value | ratio | Material | ratio | Material | ratio | Material | ratio | Material | ratio |
| Item | resin | (Ω · cm) | (%) | resin | (%) | resin | (%) | resin | (%) | resin | (%) |
| Example 16 | Conductive | 10⁶ | 10 | PBT+ | 20 | PBN | 30 | Polyester-ether | 20 | Polyester-ether | 20 |
| | PBT+ random | | | random | | | | block copolymer | | block copolymer | |
| | copolymer | | | copolymer | | | | (PBT/PTMG) | | (PBT/PTMG) | |
| Example 17 | | | 10 | PEN | 30 | — | — | — | — | | 60 |
| Example 18 | | | 10 | PET | 30 | — | — | — | — | | 60 |
| Example 19 | Conductive | 10⁶ | 2 | PBT | 20 | — | — | — | — | | 78 |
| Example 20 | polyester-ether | | 40 | | 20 | — | — | — | — | | 40 |
| Example 21 | block | | 10 | | 2 | — | — | — | — | | 88 |
| Example 22 | copolymer | | 10 | | 80 | — | — | — | — | | 10 |
| | (PBT/PTMG) | | | | | | | | | | |
| Example 23 | Conductive | 10⁶ | 5 | PBT | 30 | PBT/ | 35 | — | — | | 30 |
| | PBT+ EPR | | | | | dimer acid/ | | | | | |
| | (particle size: | | | | | PTMG | | | | | |
| | 1 μm) | | | | | | | | | | |
| Example 24 | Conductive | 10⁶ | 5 | | | | | — | — | | 30 |
| Example 25 | PBT+ EPR | | 5 | PBN | 10 | — | — | — | — | Polyester-ether | 85 |
| | (particle size: | | | | | | | | | block copolymer | |
| | 0.1 μm) | | | | | | | | | (PBT/PTMG) | |
| Example 26 | | | 5 | Polyester- | 5 | PBN | 10 | Polyester-ether | 5 | Polyester-ether | 75 |
| | | | | ether block | | | | block co- | | block co- | |
| | | | | copolymer | | | | polymer | | polymer | |
| | | | | (PBN/PTMG) | | | | (PBN/PTMG) | | (PBT/PTMG) | |

TABLE 2

| | | Permeation resistance | | Low temp. |
|---|---|---|---|---|
| | Peel | performance | | Impact |
| Item | strength | Gasoline | Alcohol-contained fuel | resistance |
| Comp. | C | C | C | B |
| example 1 | | | | |
| Comp. | — | C | D | B |
| example 1 | | | | |
| Example 1 | A | A | B | B |
| Example 2 | A | A | B | A |
| Example 3 | A | A | B | B |
| Example 4 | A | A | B | B |
| Example 5 | A | A | B | B |
| Example 6 | A | A | B | B |
| Example 7 | A | A | B | B |
| Example 8 | A | A | B | B |
| Example 9 | A | A | B | B |
| Example 10 | B | A | A | B |
| Example 11 | B | A | A | B |
| Example 12 | A | A | B | B |
| Example 13 | A | A | A | B |
| Example 14 | A | A | A | B |
| Example 15 | A | A | A | B |
| Example 16 | B | A | A | B |
| Example 17 | B | B | B | B |
| Example 18 | B | B | C | B |
| Example 19 | A | B | B | C |
| Example 20 | A | B | B | C |
| Example 21 | A | C | C | B |
| Example 22 | A | A | A | C |
| Example 23 | A | A | B | A |
| Example 24 | A | A | B | A |
| Example 25 | A | A | A | A |
| Example 26 | A | A | A | A |

What is claimed is:

1. A resinous tube comprising:
at least one first cylindrical resin layer (A) including at least one resin selected from the group consisting of polybutylene terephthalate (PBT), polybutylene naphthalate (PBN), polyethylene terephthalate (PET) and polyethylene naphthalate (PEN); and
at least one second cylindrical resin layer (B) formed generally coaxial with the at least one first cylindrical layer and including at least one of polybutylene terephthalate (PBT) copolymer and polybutylene naphthalate (PBN) copolymer,
wherein a cylindrical resin layer forming an innermost layer of the resinous tube is electrically conductive.

2. A resinous tube as claimed in claim 1, wherein the conductive cylindrical resin layer forming the innermost layer has a volume resistivity value of not higher than 10⁶ Ω·cm.

3. A resinous tube as claimed in claim 1, wherein the conductive cylindrical resin layer forming the innermost layer has a thickness within a range of from 3 to 30% of a total thickness of all the layers of the resinous tube.

4. A resinous tube as claimed in claim 1, wherein the at least one first resin layer (A) has a total thickness within a range of from 3 to 70% of a total thickness of all the layers of the resinous tube.

5. A resinous tube as claimed in claim 1, wherein the at least one second resin layer (B) further includes at least one of PBT and PBN.

6. A resinous tube as claimed in claim 1, wherein the at least one second cylindrical resin layer (B) includes a block copolymer which contains at least one of PBT and PBN as a hard segment, and at least one of polytetramethylene glycol and polycaprolactone as a soft segment.

7. A resinous tube as claimed in claim 1, wherein the at least one second cylindrical resin layer (B) includes at least one of random PBT copolymer and random PBN copolymer, constituted of a copolymer polyester which includes an acid component and glycol component, the acid component including at least one selected from the group consisting of terephthalic acid, ester-formable derivative of terephthalic acid, naphthalenedicarboxylic acid, ester-formable derivative of naphthalenedicarboxylic acid, and at least one of hydrogenated dimer acid and ester-formable derivative of hydrogenated dimer acid, the glycol component including 1,4-butanediol.

8. A resinous tube as claimed in claim 1, wherein the PBT copolymer is a copolymer polyester prepared by copolymerization of polytetramethylene glycol and a copolymer polyester which includes an acid component and glycol component, the acid component including at least one selected from the group consisting of terephthalic acid, ester-formable derivative of terephthalic acid, naphthalenedicarboxylic acid, ester-formable derivative of naphthalenedicarboxylic acid, and at least one of hydrogenated dimer acid and ester-formable derivative of hydrogenated dimer acid, the glycol component including 1,4-butanediol.

9. A resinous tube as claimed in claim 1, wherein the conductive cylindrical resin layer forming the innermost layer is formed of a resin which is constituted of a copolymer polyester including an acid component and glycol component, the acid component including at least one selected from the group consisting of terephthalic acid, ester-formable derivative of terephthalic acid, naphthalenedicarboxylic acid, ester-formable derivative of naphthalenedicarboxylic acid, and at least one of hydrogenated dimer acid and ester-formable derivative of hydrogenated dimer acid, the glycol component including 1,4-butanediol.

10. A resinous tube as claimed in claim 1, wherein the conductive resin layer forming the innermost layer is formed of a resin including polybutylene terephthalate (PBT) in which ethylene-propylene rubber (EPR) is dispersed, the resin having a volume resistivity value of not higher than 10⁶ Ω·cm.

11. A resinous tube as claimed in claim 10, wherein the ethylene propylene rubber has a particle size of not larger than 1 μm.

12. A resinous tube as claimed in claim 1, wherein the conductive cylindrical resin layer forms part of the at least one first cylindrical resin layer and the at least one second cylindrical resin layer.

13. A resinous tube as claimed in claim 1, wherein the conductive resin layer is independent from the at least one first cylindrical resin layer and the at least one second cylindrical resin layer.

14. A tube for piping in a fuel system of a vehicle, comprising:
at least one first cylindrical resin layer (A) including at least one resin selected from the group consisting of polybutylene terephthalate (PBT), polybutylene naphthalate (PBN), polyethylene terephthalate (PET) and polyethylene naphthalate (PEN); and
at least one second cylindrical resin layer (B) formed generally coaxial with the at least one first cylindrical layer and including at least one of polybutylene terephthalate (PBT) copolymer and polybutylene naphthalate (PBN) copolymer,
wherein a cylindrical resin layer forming an innermost layer of the resinous tube is electrically conductive, fuel being in direct contact with an inner surface of the innermost layer.
